(19) United States
(12) Patent Application Publication
(10) Pub. No.: US 2024/0113321 A1
(43) Pub. Date: Apr. 4, 2024

(54) METHOD FOR THE MANUFACTURE OF LOWER CAPACITY ELLIPTIC CYLINDRICAL LITHIUM ION CELLS WITH LOW INTERNAL RESISTANCE

(71) Applicant: INDIAN SPACE RESEARCH ORGANISATION, Bangalore (IN)

(72) Inventors: Aravamuthan S, Thiruvananthapuram (IN); Mercy TD, Thiruvananthapuram (IN); Vijayakumar PS, Thiruvananthapuram (IN); Aiswarya SAMRIDH, Thiruvananthapuram (IN); Bibin JOHN, Thiruvananthapuram (IN); Arjun RAJ M, Thiruvananthapuram (IN); Deepak SRIVASTAVA, Thiruvananthapuram (IN); Jamal Nawaz ANSARI, MD, Thiruvananthapuram (IN); Vijayakumar K, Thiruvananthapuram (IN); Vidur Rajesh PALIWAL, Thiruvananthapuram (IN); Vinod V, Thiruvananthapuram (IN); Padmakumar S, Thiruvananthapuram (IN); Rajesh KUMAR MR, Thiruvananthapuram (IN); Sunil K, Thiruvananthapuram (IN); Saju KT, Thiruvananthapuram (IN); Jineesh P, Thiruvananthapuram (IN); Bineeshlal K, Thiruvananthapuram (IN)

(21) Appl. No.: 18/275,572

(22) PCT Filed: Feb. 3, 2022
(86) PCT No.: PCT/IN2022/050087

§ 371 Date: Aug. 2, 2023

(30) Foreign Application Priority Data
Feb. 3, 2021 (IN) 202141004606

(51) Int. Cl. H01M 10/0525; H01M 10/0587; H01M 50/107; H01M 50/152; H01M 50/169; H01M 50/179; H01M 50/184; H01M 50/188; H01M 50/536; H01M 50/559; H01M 50/566; H01M 50/567; H01M 50/636

(52) U.S. Cl. CPC H01M 10/0525; H01M 10/0587; H01M 50/107; H01M 50/152; H01M 50/169; H01M 50/179; H01M 50/184; H01M 50/188; H01M 50/536; H01M 50/559; H01M 50/566; H01M 50/567; H01M 50/636

(57) ABSTRACT

The present invention relates to lithium ion cells and specifically to lower capacity (3-10 Ah) elliptic cylindrical lithium ion cells with individual positive and negative terminals projecting from the top of the cell. In particular, the present invention relates to lower capacity elliptic cylindrical lithium ion cells with plastic compression seals, and method of processing them. The cells of the present application exhibit good charge retention and low internal resistance and can be employed for mission critical applications viz. powering satellites, launch vehicles, military vehicles, submarines and electric vehicles.

### FIELD OF INVENTION

The present application relates to lithium ion cells and specifically to lower capacity elliptic cylindrical lithium ion cells with individual positive and negative terminals projecting from the top of the cell. In particular, the present application relates to lower capacity elliptic cylindrical lithium ion cells with plastic compression seals, and method of processing them. The cells of the present application exhibit good charge retention and low internal resistance and can be employed for mission critical applications viz. powering satellites, launch vehicles, military vehicles, submarines and electric vehicles.

### BACKGROUND OF THE INVENTION

Lithium ion cells, owing to their high voltage and energy density and low self-discharge, are the most sought after power source for various applications including mobile phones, laptops, cameras and in mission critical applications as in aircrafts, submarines, satellites and launch vehicles. Lithium ion cells consist of a cathode (eg. LiCoO2, LiFePO4 etc.), an anode (graphite, silicon, graphite-silicon etc.) and a non-aqueous electrolyte (LiPF6, LiBF4 etc. dissolved in organic solvents like ethylene carbonate, diethyl carbonate etc.). The assembly process for lithium ion cells consists of inserting an electrode stack (formed by arranging positive and negative electrodes with separator in between) into a cell case and finally sealed using a cover/lid either by welding or by crimping.

Lithium ion cells are commonly available in two configurations viz. cylindrical and prismatic. Cylindrical cells normally provide higher energy density at cell level; however, the packing efficiency at battery level is poor leading to lower energy density. There are also other disadvantages. If electrode thickness is not properly maintained, stack dimension will not be consistent making it difficult for the stack to insert into the cell case. The problem becomes severe when the electrode length increases. The heat dissipation is also poor for cylindrical cells especially at higher diameters. When battery level packing efficiency and heat dissipation aspects are considered, prismatic configuration is advantageous. The long shelf life for lithium ion cells is achieved only when the cells are hermetically sealed since the components inside the cell can react with water vapour, carbon dioxide etc. [U.S. Pat. No. 4,567,121]. Hermetically sealed lithium ion cells of lower capacities (3-10 Ah) are required for critical applications especially for micro satellites, launch vehicles etc. In order to get high current output from the cell, it is required to reduce the internal resistance, as smaller capacity cells are prone to have high internal resistance due to the smaller electrode area. Cells with individual terminals projecting from the cell are essential for certain applications as it makes the battery assembly simpler and at the same time makes it possible to replace any cell in case of any abnormality.

Prior art search resulted in the existence of following patents in this area.

Isolation between the two terminals is essential in lithium ion cells. In larger capacity prismatic lithium ion cells, the individual positive and negative terminals are separated well apart and hence are properly isolated. However, in the case of smaller capacity cells, due to the space limitations and to improve the energy density, one of the electrode tabs is connected to body of the cell in which case the body acts as one of the terminals. EP1246275A2, US 2002/0142216A1 and U.S. Pat. No. 6,586,134B2 deal with a prismatic cell in which the negative lead is welded to the case and thus forming a case negative design. In the lithium ion cell disclosed in JP2017098220A, one of the electrodes is welded to the metallic case.

U.S. Pat. No. 6,132,900 deals with a lithium ion cell in which the positive tab coming from the stack is welded to the top plate and this way the top plate and cell body acts as a terminal. In the cells with cell body acts as one terminal, the two terminals are normally very close and can lead to safety concerns during battery assembly. EP2479816A1 discloses a lithium ion cell in which the terminals are projecting from the top, but either positive or negative terminal is electrically connected to the lid to have the same potential as that of the container. EP2549562B1 discloses a lithium ion cell with separate terminals on the top, but the terminals are not threaded or not projecting much to connect a link during battery assembly. U.S. Pat. No. 8,986,874B2 deals with lithium ion cell in which individual terminals projecting from the lid are provided, but the terminals are flat with holes provided. The disadvantage with this type is that the battery assembly is easy only when the cells are arranged in the flat direction alone. However, for side by side arrangement during battery assembly, this configuration of terminal is not preferred.

Along with the physical design of the battery, the type of terminal seal that is used to seal the cell affects the durability and consequently the life of the battery. Batteries are subjected to various types of environments. If any of the environments to which the battery is exposed contains contaminants or moisture, the seal becomes extremely important. The seal acts as a protective barrier. It serves to prevent any of the contaminants or moisture from reaching the interior of the cell. In order to properly accomplish this, the seal itself must be impermeable to moisture and other contaminants [US2002/0076609A1].

A major problem that affects the durability of a battery is the breakdown of the seals that are necessary to keep electrolyte within the battery. Seals can breakdown or be damaged for many reasons, some of which include thermal shock and shear torque between the seal and its adjacent components. If damage to the seal can be prevented, then the durability of the battery can be increased thereby increasing the life of the battery [US2002/0076609A1]. Electrochemical cells must remain sufficiently sealed over long periods of time and under a broad range of temperature and relative humidity conditions in order to have satisfactory shelf life and performance as expected after shipping and storage. For this reason, the material of the seal member must remain highly stable. Since the seal member is generally exposed directly to the internal environment of the cell, it must also be stable in that environment. This means it must not deteriorate in contact with the electrolyte or electrode materials. The rate of transmission of electrolyte solvents and gases must be sufficiently slow to prevent excessive loss of electrolyte and wasteful corrosion reactions within the cell [US2003/0118902A1].

Two major type of seals used in higher capacity cells are glass to metal seals and ceramic to metal seals. These type of seals consist of an outer metal collar (which is welded to the lid) surrounding a central rod or tube and sealed together by an insulating member like glass or ceramic. The central metal rod or tube will be connected to the electrode stack inside. U.S. Pat. No. 4,233,372 and US2002/0076609A1 deal with glass to metal seals. U.S. Pat. No. 4,508,797 deals with ceramic to metal seal for lithium/iron sulfide cell. U.S. Pat. No. 5,529,858 deals with ceramic to metal seals for high temperature lithium based battery applications. U.S. Pat. No. 8,450,010B2 deals with lithium ion cells with ceramic to metal seals. U.S. Pat. No. 6,268,079B1 and U.S. Pat. No. 6,335,117B1 disclose elliptic cylindrical cells in which glass to metal and ceramic to metal seals are used. One of the disadvantages with ceramic to metal seals is the requirement of a minimum diameter for processing the seal. So for smaller capacity cells, processing of ceramic to metal seals is difficult.

U.S. Pat. No. 6,132,900 deals with construction of a lithium ion cell wherein upper peripheral edge of an opening of a bottomed cell container made of metal and the periphery of a seal plate made of metal are hermetically sealed by laser welding, a rivet serving as a terminal is inserted through hole provided on the central portion of the seal plate and hermetically fixed by crimping via a gasket. In this case the disadvantage is body is one of the terminals. U.S. Pat. No. 8,623,545 B2 deals with a plastic compression seal in which riveting is used and thus the control over preload is relatively lesser. It is difficult to ensure the same amount of preload in all assemblies which leads to different relaxation patterns among the seal assembly. Relaxation pattern of seal defines the life of cell and hence there is a little uncertainty about cell life. In U.S. Pat. No. 8,986,874 B2, the intermediate tab to electrode stack welding is done by ultrasonic welding. However, during ultrasonic welding, delamination of active material and powdering of collector foil may happen leading to micro shorts inside the cell. Ultrasonic welding also results in high internal resistance in the cell compared to fusion welding like laser welding.

To sum up, the existing prior arts on terminal seals and assembly process are having many limitations. In most of the smaller capacity cells, the body acts as one of the terminals which lead to safety concerns during battery assembly. Also, for this type of cells, welding may be required for cell-to-cell linking, which makes it difficult for the removal of any cell in case of any abnormality. The welding method adopted in prior art for electrode stack to intermediate tab welding leads to either particle generation/electrode damage or leads to high internal resistance. The plastic compression seals used in prior art is based on riveting and control over preload is relatively lesser. It is difficult to ensure the same amount of preload in all assemblies which leads to different relaxation patterns among the seal assembly. All these limitations led to the development of a new method, for processing smaller capacity lithium ion cells with individual terminals projecting at the top, which is devoid of these issues.

### OBJECTS OF THE INVENTION

The primary object of the invention is provision of lower capacity (3-10 Ah) elliptic cylindrical lithium ion cells having lower internal resistance, and with individual terminals projecting out from the top of the cell.

Still another object of the invention is processing of lower capacity cells having lower internal resistance (<12 mΩ for a typical 5 Ah cell) by adopting laser beam welding for stack to intermediate tab and intermediate tab to terminal welding.

Yet another object of the invention is the use of plastic compression seal for lower capacity elliptic cylindrical lithium ion cell.

In accordance with the aforesaid objects, the present invention provides smaller capacity lithium ion cells with individual terminals projecting at the top, enabling realisation of the above mentioned objects, and a method for their processing.

Another object of the present invention is to process cells with lower internal resistance so as to get high current output.

### BRIEF DESCRIPTION OF FIGURES

FIG. 1: Sketch of electrode stack with other components and weld joints.

FIG. 2: Sketch of the assembled cell.

FIG. 3: Sketch for the assembly of plastic compression seals to the lid.

### SUMMARY OF INVENTION

In one aspect, the present invention provides lower capacity elliptic cylindrical lithium ion cells with plastic compression seals.

In another aspect, the present invention provides a method of processing lower capacity elliptic cylindrical lithium ion cells.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition.

Thus, before describing the present invention in detail, it is to be understood that this invention is not limited to particularly exemplified systems or method parameters that may of course, vary. It is also to be understood that the terminology used herein is for the purpose of describing particular embodiments of the invention only, and is not intended to limit the scope of the invention in any manner.

The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

It must be noted that, as used in this specification and the appended claims, the singular forms “a,” “an” and “the” include plural referents unless the content clearly dictates otherwise. Thus, for example, reference to a “polymer” may include two or more such polymers.

The terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e., to mean including but not limited to.

In one aspect, the present invention provides lower capacity elliptic cylindrical lithium ion cells with plastic compression seals.

The positive electrode consists of a mixture of (a) active material selected from the group consisting of Lithium Cobalt Oxide (LiCoO2), Lithium Nickel Cobalt Aluminium Oxide (LiNi0.8Co0.15Al0.05O2), Lithium Nickel Cobalt Manganese Oxide (LiNi0.8Co0.1Mn0.1O2, LiNi0.6Co0.2Mn0.2O2, LiNi0.5Mn0.3Co0.2O2, LiNi0.33Mn0.33Co0.33O2), Lithium Iron Phosphate (LiFePO4) (b) conducting agent (eg. acetylene black, graphite etc.) and (c) binder (eg. Polyvinylidene fluoride) coated on aluminium foil. The positive electrode composition is: Active material: 80-95%, conducting agent: 2-8%, binder: 3-10%. The final thickness of the positive electrode is 130-200 μm.

The negative electrode consists of a mixture of (a) active material (selected from the group consisting of graphite, graphite-Si composite, etc.) and (b) binder (eg. polyvinylidene fluoride, carboxy methyl cellulose, styrene butadiene etc.) coated on copper foil. The negative electrode composition is: Active material: 85-97%, binder: 2-8%. The final thickness of the negative electrode is 100-200 μm.

The terminal seal (23, 24) is a plastic compression seal. The central terminal post (13) of the seal (23, 24) is provided with M4 to M6 thread above the seal (23, 24) and a provision for welding the intermediate tab (4, 5) below the seal (23, 24). The components of the plastic compression seal (23, 24) include central terminal post (13), top insulator (14) and bottom insulator (16) (selected from the group consisting of PTFE, perfluoroalkoxy alkane etc.), compressible insulating material (15) and a half nut (17). These components are assembled on the lid (12) to get a leak proof assembly.

In the terminal seal (23, 24), a ring made of compressible insulating material (15) having a transition fit with stud (21, 22) and/or hole is provided in the lid (12) during insertion. The ring (15) is sandwiched between top and bottom insulators (14, 16). During tightening, the ring (15) is compressed axially and thus expands radially to generate radial pressure with stud (21, 22) and lid (12) for leak tightness.

The terminal seal (23, 24) in the present patent is capable to achieve the leak rate less than 1×10−8 mbar-1/s.

The present invention doesn't include any groove for placing of individual components hence less precision required for fabrication of components.

All components are axis-symmetric and are concentric about a single axis and hence self-aligning. The present invention makes use of cavity created by top and bottom insulator for volumetric compression of gasket and thus achieves its leak tightness. The present invention uses threaded joints for preload and hence rework is easy.

The hermetically sealed lithium ion cells (18) of the present invention have a capacity of 3 to 10 Ah with very high capacity retention for various applications, and have low internal resistance of less than 2 mat. Helium leak rate achieved is less than 10-8 mbar-Vs. The cell manufactured is subjected to charge-discharge cycles for 2500 cycles at 100% depth-of-discharge. The capacity retention is >80% of the initial capacity.

The lower capacity cells (18) of the present invention provide the following advantages:

Reduction in cost: The cost of plastic compression seals (23, 24) is much less than the traditionally used ceramic to metal seals.

Easy to process: Plastic compression seals (23, 24) are easy to process compared to ceramic to metal seals.

Easy to assemble: Plastic compression seals (23, 24) are easy to assemble to lid (12) compared to ceramic metal seals, as it involves only tightening of the components and no welding is involved.

Ease in assembly: Cell (18) to cell (18) connection in battery can be easily done using a link and nut.

Safety: As the terminals (10, 11) are well separated, improves the safety of the cell (18).

Replacement: Replacement of cells (18) from a battery is easy as there is no welding involved in battery assembly

The lower capacity cells (18) of the present application have lower internal resistance compared to commercially available lower capacity cells. Heat transfer to the stack/separator due to lower width of the bare foil on the electrode leads to high self-discharge or short circuit in the case of lower capacity cells. This issue is addressed by the use of specialized intermediate tab (4, 5) and specialized heat sinks to reduce the heat transfer to the electrode stack (1) and separator. Glass Teflon sheet is also used to avoid heat transfer to the separator and electrode stack (1).

The lower capacity cell (18) of the present invention is capable of withstanding vibration up to 15.52 grms and shock level up to 50 g (10 msec). The capability to withstand vibration level and shock depends mainly on the robustness of the cell (18) design. This is advantageous especially for launch vehicles and electric vehicles, as the both the vehicles can undergo different vibration and shock levels.

The cells (18) are capable of working in the temperature range from 5 to 60° C. The cells (18) are safe during overcharge, and over discharge and short circuit at 3.5 V. The cell (18) has very low self-discharge characteristics (<2 mV/day when charged to 30-40% SOC). The cell (18) has good charge retention with >95% capacity retention when charged at 4.1 V for one week, and the cell (18) is capable of working under vacuum conditions of 10-6 mbar. No leak was observed under these conditions.

The internal resistance of the cell (18) is 10-12 mΩ. The cell (18) is capable of withstanding random vibration level up to 15.52 grms, and the cell (18) is capable of withstanding shock level up to 50 g (10 msec).

In another aspect, the present invention provides a method of processing lower capacity elliptic cylindrical lithium ion cells (18).

The method for processing comprises the steps of:
electrode processing;
electrode stack (1) winding;
cell (18) assembly; and
cell (18) activation, testing and fill plug welding.

### Electrode Processing

Electrode processing involves coating of active materials on aluminium and copper foil respectively for the processing of positive and negative electrodes.

The positive electrode comprises a mixture of (a) active material selected from the group consisting of Lithium Cobalt Oxide (LiCoO2), Lithium Nickel Cobalt Aluminium Oxide (LiNi0.8Co0.15Al0.05O2) and Lithium Nickel Cobalt Manganese Oxide (LiNi0.8Co0.1Mn0.1O2, LiNi0.6Co0.2Mn0.2O2, LiNi0.5Mn0.3Co0.2O2, LiNi0.33Mn0.33Co0.33O2), Lithium Iron Phosphate (LiFePO4) (b) conducting agent (eg. acetylene black, graphite) and (c) binder (eg. Polyvinylidene fluoride) coated on aluminium foil.

In an embodiment, the composition of the positive electrode composition is: Active material: 80-95%, conducting agent: 2-8%, binder: 3-10%.

The final thickness of the positive electrode ranges from 130-200 μm.

The negative electrode comprises a mixture of (a) active material (selected from the group consisting of graphite, graphite-Si composite, etc.) and (b) binder (eg. polyvinylidene fluoride, carboxy methyl cellulose, styrene butadiene etc.) coated on copper foil.

In an embodiment, the composition of negative electrode is Active material: 85-97%, binder: 2-8%.

The final thickness of the negative electrode ranges from 100-200 μm.

Solvents selected from 1-methyl-2-pyrrolidinone (NMP), dimethyl acetamide (DMAC), dimethyl formamide (DMF), water etc. may be used for processing of the electrodes.

In an embodiment, 1-methyl-2-pyrrolidinone (NMP) is used as solvent for the processing of the electrode slurry when polyvinylidene fluoride is used as binder. Water is used as solvent for the processing of electrode slurry when carboxy methyl cellulose or styrene butadiene is used as binder.

The positive and negative electrodes preferably have 4-10 mm and 5-11 mm bare area respectively provided throughout the length of the electrodes to provide electrical feed through.

### Electrode Stack Winding

An electrode stack (1) can be made by winding the positive and negative electrodes with separator in between in a winding machine using a flat mandrel. The separator width may range from 2-8 mm more than the negative electrode coating width. The winding is done in such a way that the uncoated areas of positive electrode and negative electrode project from opposite sides of the stack. The positive substrate projected width is 2 to 10 mm and negative substrate projected width is 3 to 10 mm. The negative electrode extends beyond the length and width of the positive electrode.

In an embodiment, the electrode stack (1) is made by winding 1.5-2.5 m positive and 1.7-2.7 m of negative electrodes for a typical 5 Ah cell with separator 1.9-2.9 m in between in a winding machine using a flat mandrel.

### Cell Assembly

The electrode stack (1) winding and assembly of the cell (18) are to be carried out in humidity controlled environment with RH<1%. The following are the different steps involved in cell (18) assembly.

### Lid-Terminal Seal Assembly

This step involves assembling the terminal seals (23, 24) (positive and negative) with the top cover or lid (12) made of an aluminium alloy. The terminal seal (23, 24) is a plastic compression seal. The components of plastic compression seal (23, 24) include central terminal post (13), top insulator (14) and bottom insulator (16) (selected from the group consisting of PTFE, perfluoroalkoxy alkane etc.), compressible insulating material (15) and a half nut (17). These components are assembled on the lid (12) to get a leak proof assembly. The central terminal post (13) of the seal (23, 24) is provided with M4 to M6 thread above the seal (23, 24) and a provision for welding the intermediate tab (4, 5) below the seal (23, 24).

During assembly of terminal seal (23, 24), top insulator (14) is inserted through hole provided in lid (12) ensuring the surface contact of insulator flange with top projection in lid (12). The terminal stud (21, 22) is inserted through top insulator (14) ensuring the contact of stud (21, 22) flange with insulator flange. Compressible insulating material (15) in form of a ring is inserted through the stud (21, 22) from bottom followed by bottom insulator (16). Subsequently, a half nut (17) is inserted and then tightened to a predefined torque. During assembly of terminal seal (23, 24), the ring made of compressible insulating material (15) may have a transition fit with stud (21, 22) and/or hole provided in lid (12) during insertion. The ring (15) will be sandwiched between top and bottom insulators (14, 16). During tightening, the ring (15) is compressed axially and thus expands radially to generate radial pressure with stud (21, 22) and lid (12) for leak tightness.

### Welding of Intermediate Tab to Stack

The half portion of the aluminium bare side of the stack (1) is divided into two equal groups. The grouped aluminium foils are inserted into the grooves of the positive intermediate tab (4) and crimp. Similarly, the half portion of the copper bare side of the stack (1) is divided into two equal groups. The grouped copper foils are inserted into the grooves of the negative intermediate tab (5) and crimp.

The electrode stack (1) is kept with intermediate tabs (4, 5) attached on it in welding workstation with positive intermediate tab (4) on the top. LASER (IR) head is focused over positive intermediate tab (4)-stack (1) interface. The Argon gas nozzle is focused over the positive intermediate tab (4)-stack (1) interface and welding is carried out at a peak power of 5-8 kW with the use of a heat sink made of copper to reduce the heat transfer to the separator. Additionally, a thermal insulating layer such as glass-PTFE sheet is placed in between stack (1) and the positive intermediate tab (4) in order to protect the separator from heat. The stack (1) in the welding workstation is kept with negative intermediate tab (5) on the top. LASER (IR) head is focused over negative intermediate tab (5)-stack (1) interface.

The Argon gas nozzle is focused over negative intermediate tab (5)-stack (1) interface and welding is carried out at a peak power of 4-7 kW with the use of a heat sink made of copper to reduce the heat transfer to the separator.

### Welding of Intermediate Tabs to Lid-Terminal Assembly

This step involves fixing of the terminal lugs (19, 20) on the respective intermediate tabs (4, 5) firmly. The LASER head is focussed over the positive intermediate tab (4)-positive terminal lug (19, 20) interface. The Argon gas nozzle is focussed over the positive intermediate tab (4)-positive terminal lug (19, 20) interface and welding is carried out at a peak power of 5-8 kW. The laser head is focussed over the negative intermediate tab (5)-negative terminal lug (19, 20) interface and welding is carried out at a peak power of 4-7 kW. The intermediate tabs (4, 5) are carefully bent such that the terminal (23, 24)-lid (12) assembly comes over the stack (1).

### Case to Lid Welding

The electrode stack (1) is inserted in this step with lid (12)-terminal (23, 24) assembly into an aluminium alloy cell case such that the terminals (10, 11) face upward. The LASER head and Argon gas nozzle are focussed over case to lid (12) interface and case to lid (12) welding is carried out. The laser power for case to lid (12) welding ranges from 5-8 kW.

### Cell Activation, Testing and Fill Plug Welding

This step involves adding the required quantity of electrolyte to the cell (18) through the fill port provided on the top lid (12) and then allowing to soak for a period of 2-5 days. After this the cell (18) is subjected to formation cycling at C/10 to 1C charge-discharge rate. The gases generated during formation are vented out and the fill port is finally sealed using laser beam welding. The laser peak power ranges from 4-8 kW.

The helium leak rate of the cell (18) is less than 10-8 mbar-l/s. The internal resistance of the cell (18) is 10-12 mΩ (for a typical 5 Ah cell). The low value of internal resistance is achieved by the use of laser beam welding for intermediate tab (4, 5) to electrode stack (1) welding. Laser beam welding gives a strong weldment with increased depth of penetration and contact area between substrate foils of the electrode and the intermediate tab (4, 5). Increased contact area with minimum undulations of the weld nugget reduce the internal resistance of the cell (18).

The cells (18) manufactured by the method can be employed for mission critical applications viz. powering satellites, launch vehicles, aircrafts, military vehicles, submarines and electric vehicles.

The following examples are provided to better illustrate the claimed invention and are not to be interpreted in any way as limiting the scope of the invention. All specific materials, and methods described below, fall within the scope of the invention. These specific compositions, materials, and methods are not intended to limit the invention, but merely to illustrate specific embodiments falling within the scope of the invention. One skilled in the art may develop equivalent materials, and methods without the exercise of inventive capacity and without departing from the scope of the invention. It is the intention of the inventors that such variations are included within the scope of the invention.

### Example 1

The example given below illustrates the processing of lower capacity elliptic cylindrical cells (18) with LiCoO2/LiNi0.8Co0.15Al0.05O2 cathode and graphite anode.

### Electrode Processing

Electrode processing involves coating of active materials on aluminium and copper foil respectively for the processing of positive and negative electrodes.

The positive electrode comprises a mixture of (a) Lithium Cobalt Oxide (LiCoO2) or Lithium Nickel Cobalt Aluminium Oxide (LiNi0.8Co0.15Al0.05O2) (b) conducting agent (acetylene black and graphite) and (c) Polyvinylidene fluoride coated on aluminium foil. The composition of the positive electrode is LiCoO2/LiNi0.8Co0.15Al0.05O2 active material: 85-90%, conducting agent: 2-6%, binder: 4-6%. The final thickness of the positive electrode after calendering ranges from 150-160 μm. 1-methyl-2-pyrrolidinone is used as solvent for slurry preparation.

The negative electrode comprises a mixture of (a) graphite and (b) polyvinylidene fluoride coated on copper foil. The composition of negative electrode is graphite: 90-96%, binder: 3-6%. The final thickness of the negative electrode ranges from 150-160 μm. 1-methyl-2-pyrrolidinone is used as solvent for slurry preparation.

The positive and negative electrodes have 4-8 mm and 5-8 mm bare area respectively provided throughout the length of the electrodes to provide electrical feed through.

### Electrode Stack Winding

An electrode stack (1) is made by winding the positive and negative electrodes with separator in between in a winding machine using a flat mandrel. The separator width is 4-6 mm more than the negative electrode coating width. The winding is done in such a way that the uncoated areas of positive electrode and negative electrode project from opposite sides of the stack (1). The positive electrode substrate projected width is 3 to 6 mm and negative electrode substrate projected width is 3 to 6 mm. The negative electrode extends beyond the length and width of the positive electrode. The length of positive electrode, negative electrode and separator is 2.0, 2.2 and 2.5 m respectively.

### Cell Assembly

The electrode stack (1) winding and assembly of the cell (18) are carried out in humidity controlled environment with RH<1%. The following are the different steps involved in cell assembly.

### Lid-Terminal Seal Assembly

This step involves assembling the terminal seals (23, 24) (positive and negative) with the top cover or lid (12) made of an aluminium alloy. The terminal seal (23, 24) is a plastic compression seal. The components of plastic compression seal (23, 24) include central terminal post (13), top insulator (14) and bottom insulator (16) made of PTFE, compressible insulating material (15) and a half nut (17). These components are assembled on the lid (12) to get a leak proof assembly. The central terminal post (13) of the seal (23, 24) is provided with M4 thread above the seal (23, 24) and a provision for welding the intermediate tab (4, 5) below the seal (23, 24). During assembly of terminal seal (23, 24), top insulator (14) is inserted through hole provided in lid (12) ensuring the surface contact of insulator flange with top projection in lid (12). The terminal stud (21, 22) is inserted through top insulator (14) ensuring the contact of stud flange with insulator flange. Compressible insulating material (15) in form of a ring is inserted through the stud (21, 22) from bottom followed by bottom insulator (16). Subsequently, a half nut (17) is inserted and then tightened to a predefined torque.

### Welding of Intermediate Tab to Stack

The half portion of the aluminium bare side of the stack (1) is divided into two equal groups. The grouped aluminium foils are inserted into the grooves of the positive intermediate tab (4) and crimp. Similarly, the half portion of the copper bare side of the stack (1) is divided into two equal groups. The grouped copper foils are inserted into the grooves of the negative intermediate tab (5) and crimp.

The electrode stack (1) is kept with intermediate tabs (4, 5) attached on it in welding workstation with positive intermediate tab (4) on the top. LASER (IR) head is focussed over positive intermediate tab (4)-stack (1) interface. The Argon gas nozzle is focussed over positive intermediate tab (4)-stack (1) interface and welding is carried out at a peak power of 5-8 kW with the use of a heat sink made of copper to reduce the heat transfer to the separator. Additionally, a thermal insulating layer such as glass-PTFE sheet is placed in between stack (1) and positive intermediate tab (4) in order to protect the separator from heat. The stack (1) is kept with negative intermediate tab (5) on the top. LASER (IR) head is focussed over negative intermediate tab (5)-stack (1) interface. The Argon gas nozzle is focussed over negative intermediate tab (5)-stack (1) interface and welding is carried out at a peak power of 4-7 kW with the use of a heat sink made of copper to reduce the heat transfer to the separator.

### Welding of Intermediate Tabs to Lid-Terminal Assembly

This step involves fixing of the terminal lugs (19, 20) on the respective intermediate tabs (4, 5) firmly. The LASER head is focussed over the positive intermediate tab (4)-positive terminal lug (19, 20) interface. The Argon gas nozzle is focussed over the positive intermediate tab (4)-positive terminal lug (19, 20) interface and welding is carried out at a peak power of 5-8 kW. The laser head is focussed over the negative intermediate tab (5)-negative terminal lug (19, 20) interface and welding is carried out at a peak power of 4-7 kW. The intermediate tabs (4, 5) are carefully bent such that the terminal (23, 24)-lid (12) assembly comes over the stack (1).

### Case to Lid Welding

The electrode stack (1) is inserted in this step with lid (12)-terminal (23, 24) assembly into an aluminium alloy cell case such that the terminals (10, 11) face upward. The LASER head and Argon gas nozzle are focussed over case to lid (12) interface and case to lid (12) welding is carried out. The laser power for case to lid (12) welding is 5-8 kW.

### Cell Activation, Testing and Fill Plug Welding

The required quantity of electrolyte is added to the cell (18) through the fill port provided on the top lid (12) and then allowed to soak for a period of 2-5 days. After this the cell (18) is subjected to formation cycling at C/10 charge-discharge rate. The gases generated during formation can be vented out and the fill port is finally sealed using laser beam welding. The laser peak power is 4-8 kW.

### Example 2

The example given below illustrates the processing of lower capacity elliptic cylindrical cells (18) with Lithium Nickel Cobalt Manganese Oxide (LiNi0.8Co0.1Mn0.1O2 or LiNi0.6Co0.2Mn0.2O2 or LiNi0.5Mn0.3Co0.2O2)/Lithium Iron Phosphate (LiFePO4) cathode and graphite-Si composite anode.

### Electrode Processing

Electrode processing involves coating of active materials on aluminium and copper foil respectively for the processing of positive and negative electrodes.

The positive electrode comprises a mixture of (a) Lithium Nickel Cobalt Manganese Oxide (eg. LiNi0.8Co0.1Mn0.1O2 or LiNi0.6Co0.2Mn0.2O2 or LiNi0.5Mn0.3Co0.2O2)/Lithium Iron Phosphate (LiFePO4), (b) conducting agent (acetylene black and graphite) and (c) Polyvinylidene fluoride coated on aluminium foil. The composition of the positive electrode is Lithium Nickel Cobalt Manganese Oxide: 88-94%, conducting agent: 3-5%, Polyvinylidene fluoride: 3-6%. The final thickness of the positive electrode after calendering is 160-180 μm.

The negative electrode comprises a mixture of (a) Graphite-Si composite, and (b) binder (carboxy methyl cellulose, styrene butadiene etc.) coated on copper foil. The composition of negative electrode is Graphite-Si: 90-96%, binder: 3-6%. The final thickness of the negative electrode after calendering is 110-140 μm. Water is used as solvent for the processing of the negative electrode slurry.

The positive and negative electrodes have 4-8 mm and 5-8 mm bare area respectively provided throughout the length of the electrodes to provide electrical feed through.

### Electrode Stack Winding

The separator width is 4-6 mm more than the negative electrode coating width. The winding is done in such a way that the uncoated areas of positive electrode and negative electrode project from opposite sides of the stack (1). The positive electrode substrate projected width is 3 to 6 mm and negative electrode substrate projected width is 3 to 6 mm. The negative electrode extends beyond the length and width of the positive electrode. The length of positive electrode, negative electrode and separator is 1.8, 2.0 and 2.3 m respectively.

### Cell Assembly

The electrode stack (1) winding and assembly of the cell (18) are carried out in humidity controlled environment with RH<1%. The following are the different steps involved in cell (18) assembly.

### Lid-Terminal Seal Assembly

This step involves assembling the terminal seals (23, 24) (positive and negative) with the top cover or lid (12) made of an aluminium alloy. The terminal seal (23, 24)_is a plastic compression seal. The components of plastic compression seal (23, 24) include central terminal post (13), top and bottom insulator (14, 16) made of PTFE, compressible insulating material (15) and a half nut (17). These components are assembled on the lid (12) to get a leak proof assembly. The central terminal post (13) of the seal (23, 24) is provided with M5 thread above the seal (23, 24) and a provision for welding the intermediate tab (4, 5) below the seal (23, 24).

During assembly of terminal seal (23, 24), top insulator (13) is inserted through hole provided in lid (12) ensuring the surface contact of insulator flange with top projection in lid (12). The terminal stud (21, 22) is inserted through top insulator (13) ensuring the contact of stud flange with insulator flange. Compressible insulating material (15) in form of a ring is inserted through the stud (21, 22) from bottom followed by bottom insulator (16). Subsequently, a half nut (17) is inserted and then tightened to a predefined torque.

### Welding of Intermediate Tab to Stack

The half portion of the aluminium bare side of the stack (1) is divided into two equal groups. The grouped aluminium foils are inserted into the grooves of the positive intermediate tab (4) and crimp. Similarly, the half portion of the copper bare side of the stack (1) is divided into two equal groups. The grouped copper foils are inserted into the grooves of the negative intermediate tab (5) and crimp.

The electrode stack (1) is kept with intermediate tabs (4, 5) attached on it in welding workstation with positive intermediate tab (4) on the top. LASER (IR) head is focussed over positive intermediate tab (4)-stack (1) interface. The Argon gas nozzle is focussed over positive intermediate tab (4)-stack (1) interface and welding is carried out at a peak power of 5-8 kW with the use of a heat sink made of copper to reduce the heat transfer to the separator. Additionally, a thermal insulating layer such as glass-PTFE sheet is placed in between stack (1) and positive intermediate tab (4) in order to protect the separator from heat. The stack (1) is kept with negative intermediate tab (5) on the top. LASER (IR) head is focussed over negative intermediate tab (5)-stack (1) interface. The Argon gas nozzle is focussed over negative intermediate tab (5)-stack (1) interface and welding is carried out at a peak power of 4-7 kW with the use of a heat sink made of copper to reduce the heat transfer to the separator.

### Welding of Intermediate Tabs to Lid-Terminal Assembly

This step involves fixing of the terminal lugs (19, 20) on the respective intermediate tabs (4, 5) firmly. The LASER head is focussed over the positive intermediate tab (4)-positive terminal lug (19, 20) interface. The Argon gas nozzle is focussed over the positive intermediate tab (4)-positive terminal lug (19, 20) interface and welding is carried out at a peak power of 5-8 kW. The laser head is focussed over the negative intermediate tab (5)-negative terminal lug (19, 20) interface and welding is carried out at a peak power of 4-7 kW. The intermediate tabs (4, 5) are carefully bent such that the terminal (23, 24)-lid (12) assembly comes over the stack (1).

### Case to Lid Welding

The electrode stack (1) is inserted in this step with lid (12)-terminal (23, 24) assembly into an aluminium alloy cell case such that the terminals (10, 11) face upward. The LASER head and Argon gas nozzle are focussed over case to lid (12) interface and case to lid (12) welding is carried out. The laser power for case to lid (12) welding ranges from 5-8 kW.

### Cell Activation, Testing and Fill Plug Welding

This step involves adding the required quantity of electrolyte to the cell (18) through the fill port provided on the top lid (12) and then allowed to soak for a period of 2-5 days. After this the cell (18) is subjected to formation cycling at C/10 charge-discharge rate. The gases generated during formation are vented out and the fill port is finally sealed using laser beam welding. The laser peak power ranges from 4-8 kW.

### REFERENCE NUMERALS

FIG. 1:
1. Electrode stack
2. Aluminium bare foil
3. Copper bare foil
4. Positive intermediate tab
5. Negative intermediate tab
6. Electrode stack to positive intermediate tab weld joint
7. Electrode stack to negative intermediate tab weld joint
8. Positive intermediate tab to terminal weld joint
9. Negative intermediate tab to terminal weld joint
18. Lithium ion cell

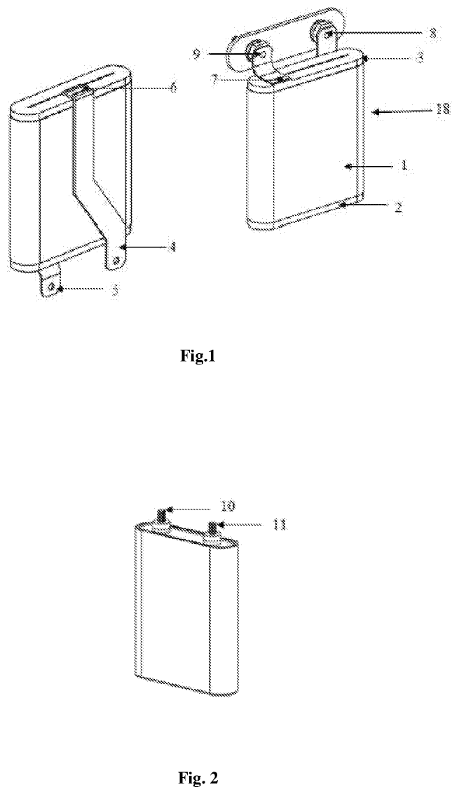

FIG. 2:
10. Positive terminal
11. Negative terminal

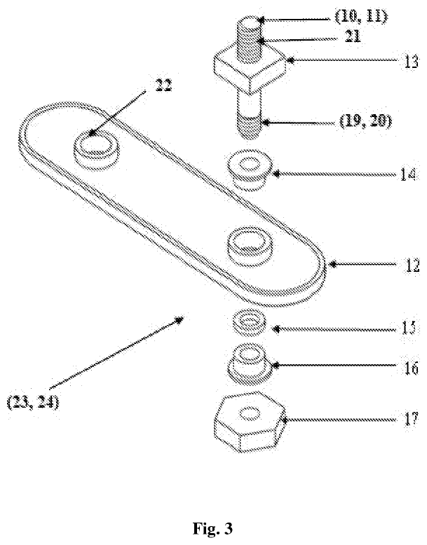

FIG. 3:
12. Lid
13. Central terminal post
14. Top insulator
15. Compressible insulating material
16. Bottom Insulator
17. Half nut
(19, 20) Positive and Negative terminal lug
(21, 22) Terminal stud
(23, 24) Terminal seal

1.-41. (canceled)

42. A lower capacity lithium ion cell comprising:
an electrode stack made of a positive electrode and a negative electrode;
a positive intermediate tab welded to one end of the electrode stack and a negative intermediate tab welded to the opposite end of the electrode stack;
a positive and a negative terminal seal assembly comprising a central terminal post, a top insulator, a bottom insulator, an insulating material, and a half nut;
a terminal stud attached with a lid by means of the positive and negative terminal seal assembly;
the terminal stud having a positive terminal lug fixed on the positive intermediate tab and the another terminal stud having a negative terminal lug fixed on the negative intermediate tab;
a fill port provided on the top of the lid;
an electrolyte added to the lithium ion cell through the fill port;
a lithium ion cell case; and
a positive and negative terminal projected out from the lithium ion cell case;
wherein the positive and negative terminal seal assembly comprises a ring made of the insulating material having a transition fit with the terminal stud and a hole provided in the lid, the bottom insulator and the half nut for tightening, the ring is sandwiched between the top insulator and the bottom insulator.

43. A method for processing a lower capacity lithium ion cell comprising an electrode stack made of a positive electrode and a negative electrode, the method comprising the steps of:
coating of active materials on the positive and negative electrode;
winding the positive and negative electrode via a separator;
welding a positive intermediate tab to one end of the electrode stack and negative intermediate tab to the opposite end of the electrode stack;
attaching a terminal stud with a lid by means of a positive and negative terminal seal assembly; the positive and negative terminal seal assembly comprising a central terminal post, a top insulator, a bottom insulator, an insulating material, and a half nut;
fixing the terminal stud having a positive terminal lug on the positive intermediate tab and fixing the another terminal stud having a negative terminal lug on the negative intermediate tab;
adding an electrolyte to the lithium ion cell through a fill port provided on the top of the lid; and
sealing the fill port via welding, wherein the attaching includes inserting the top insulator through a hole provided in lid from top followed by terminal stud, inserting from the bottom insulating material followed by the bottom insulator and the half nut and tightening to a predefined torque.

44. The method as claimed in claim 43, wherein the coating of active materials on the positive and negative electrode involves coating of active materials on aluminum and copper foil respectively.

45. The method as claimed in claim 44, wherein the positive electrode consists of a mixture of (a) active material selected from the group consisting of Lithium Cobalt Oxide (LiCoO2), Lithium Nickel Cobalt Aluminum Oxide (LiNi0.8Co0.15Al0.05O2), Lithium Nickel Cobalt Manganese Oxide (LiNi0.8Co0.1Mn0.1O2, LiNi0.6Co0.2Mn0.2O2, LiNi0.5Mn0.3Co0.2O2, LiNi0.33Mn0.33Co0.33O2), Lithium Iron Phosphate (LiFePO4); (b) a conducting agent; and (c) a binder coated on aluminum foil.

46. The method as claimed in claim 44, wherein the positive electrode composition having a final thickness of 130-200 μm, is: Active material: 80-95%, conducting agent: 2-8%, binder: 3-10%.

47. The method as claimed in claim 44, wherein the negative electrode consists of a mixture of (a) active material further defined as graphite or Graphite-Si composite; and (b) binder further defined as polyvinylidene fluoride, carboxy methyl cellulose or styrene butadiene coated on copper foil.

48. The method as claimed in claim 44, wherein the negative electrode composition having a final thickness of 100-200 μm, is: Active material: 85-97%, binder: 2-8%.

49. The method as claimed in claim 44, wherein 1-methyl-2-pyrrolidinone (NMP) is used as solvent for the processing of the electrode slurry when polyvinylidene fluoride is used as binder and water is used as solvent for the processing of electrode slurry when carboxy methyl cellulose or styrene butadiene is used as binder.

50. The method as claimed in claim 44, wherein the positive and negative electrodes have 4-10 mm and 5-11 mm bare area respectively provided throughout the length of the electrodes to provide electrical feed through.

51. The method as claimed in claim 43, wherein the electrode stack is made by winding the positive and negative electrodes via a separator in between in a winding machine using a flat mandrel.

52. The method as claimed in claim 51, wherein the positive substrate projected width is 2 to 10 mm and negative substrate projected width is 3 to 10 mm and the separator width is 2-8 mm more than the negative electrode coating width;
wherein the negative electrode extends beyond the length and width of the positive electrode.

53. The method as claimed in claim 51, wherein the winding the positive and negative electrodes is done in such a way that the uncoated areas of the positive electrode and the negative electrode project from opposite sides of the electrode stack.

54. The method as claimed in claim 43, wherein the attaching a terminal stud with a lid for assembly of the lithium ion cell involves the lid positive and negative terminal seal assembly, welding of the intermediate tab to the electrode stack, welding of the intermediate tab to the lid terminal assembly, inserting the electrode stack with the lid terminal assembly into the lithium ion cell case and the lithium ion cell case to the lid welding;
wherein the terminal stud is inserted through the top insulator ensuring the contact of the terminal stud flange with the insulator flange;
wherein the assembly of the lithium ion cell is carried out in humidity controlled environment with RH<1%;
wherein the lid terminal assembly involves assembling the positive and negative terminal seal assembly with the top cover or the lid made of an aluminum alloy; and
wherein the positive and negative terminal seal assembly is a plastic compression seal.

55. The method as claimed in claim 54, wherein the terminal post of the positive and negative terminal seal assembly is provided with M4 to M6 thread above the positive and negative terminal seal assembly and a provision for welding the intermediate tab below the positive and negative terminal seal assembly;
wherein the assembly of the positive and negative terminal seal assembly involves inserting the top insulator through the hole provided in the lid ensuring the surface contact of the insulator flange with top projection in the lid.

56. The method as claimed in claim 54, the components wherein the central terminal post, the top and bottom insulator are further defined as comprising PTFE or perfluoroalkoxy alkane, the insulating material and the half nut are assembled on the lid to get a leak proof assembly;
wherein the insulating material is inserted into the terminal stud from bottom followed by the bottom insulator and the half nut and tightening to a predefined torque.

57. The method as claimed in claim 54, wherein the welding of the positive intermediate tab to one end of the electrode stack involves dividing the half portion of aluminum bare side of the electrode stack into two equal groups;
wherein the welding of the positive intermediate tab to the opposite end of the electrode stack involves inserting the grouped aluminum foils into the grooves of the positive intermediate tab and crimping;
wherein the welding of the negative intermediate tab to the electrode stack involves dividing the half portion of copper bare side of the electrode stack into two equal groups;
wherein the welding of the negative intermediate tab to the electrode stack involves inserting the grouped copper foils into the grooves of the negative intermediate tab and crimping;
wherein the welding of the positive intermediate tab to the electrode stack involves focusing a LASER head and argon gas nozzle over the positive intermediate tab-electrode stack interface and carrying out the welding at a peak power of 5-8 kW with the use of a heat sink made of copper to reduce the heat transfer to the separator;
wherein the welding of the negative intermediate tab to the electrode stack involves focusing the LASER head and argon gas nozzle over the negative intermediate tab electrode stack interface and carrying out the welding at a peak power of 4-7 kW with the use of a heat sink made of copper to reduce the heat transfer to the separator;
wherein the welding of the positive intermediate tab to the electrode stack interface involves use of a thermal insulating sheet to protect the separator from heat;
wherein the welding of the intermediate tab to the lid terminal assembly involves fixing the terminal lugs on the respective intermediate tab;
wherein the welding of the positive intermediate tab to the lid terminal assembly involves focusing the LASER head and argon gas nozzle over the positive intermediate tab-positive terminal lug interface and carrying out the welding at a peak power of 5-8 kW; and
wherein the welding of the negative intermediate tab to the lid terminal assembly involves focusing the LASER head and argon gas nozzle over the negative intermediate tab-negative terminal lug interface and carrying out welding at a peak power of 4-7 kW.

58. The method as claimed in claim 54, wherein bending the intermediate tabs such that the terminal lid assembly comes over the stack.

59. The method as claimed in claim 54, wherein the case to lid welding involves inserting the electrode stack with the lid terminal assembly into the lithium ion cell case such that the terminals face upward;
wherein the case to lid welding involves focusing the LASER head and Argon gas nozzle over the case to lid interface and carry out the case to lid welding at a power of 5-8 kW.

60. The method as claimed in claim 43, wherein the adding an electrolyte to the lithium ion cell through the fill port provided on the top lid is followed by allowing it to soak for a period of 2-5 days;
wherein the fill port is sealed by crimping followed by the laser beam welding at a peak power of 4-8 kW.

61. The method as claimed in claim 43, wherein the lithium ion cell is subjected to formation cycling at C/10 to 1C charge-discharge rate.
